(19) United States
(12) Patent Application Publication
(10) Pub. No.: US 2018/0095819 A1
(43) Pub. Date: Apr. 5, 2018

(54) INCIDENT ANALYSIS PROGRAM, INCIDENT ANALYSIS METHOD, INFORMATION PROCESSING DEVICE, SERVICE IDENTIFICATION PROGRAM, SERVICE IDENTIFICATION METHOD, AND SERVICE IDENTIFICATION DEVICE

(71) Applicant: FUJITSU LIMITED, Kawasaki-shi (JP)

(72) Inventors: Kazunori Kandani, Nagoya (JP); Kiyoshi KOUGE, Kuwana (JP); Hiroshi Iyobe, Yokohama (JP); Takaaki Nakazawa, Kobe (JP); Shunichi Obinata, Kawasaki (JP)

(73) Assignee: FUJITSU LIMITED, Kawasaki-shi (JP)

(21) Appl. No.: 15/700,812

(22) Filed: Sep. 11, 2017

(30) Foreign Application Priority Data
Oct. 4, 2016 (JP) 2016-196731

(51) Int. Cl. G06F 11/07; G06F 17/30

(52) U.S. Cl. CPC G06F 11/0787; G06F 11/0727; G06F 17/30345

(57) ABSTRACT

A non-transitory computer-readable storage medium storing an incident analysis program having: generating a new incident-related request database by extracting, from a request management database including request data in which requests issued from first service systems of a first cloud service vendor to second service systems of a second cloud service vendor, response times to the requests, and timings of the requests, new incident-related request data of requests issued at the new incident occurred from an issuing source first service system to an issuing destination second service system; extracting, from a plurality of past incident-related request databases generated at incidents in the past, a past incident-related request database whose transition tendency of the response time has a correlation with the new incident-related request database: and identifying a second service system estimated to be responsible for the past incident, as a second service system estimated to be responsible for the new incident.

### CROSS-REFERENCE TO RELATED APPLICATION

This application is based upon and claims the benefit of priority of the prior Japanese Patent Application No. 2016-196731, filed on Oct. 4, 2016, the entire contents of which are incorporated herein by reference.

### FIELD

The present invention relates to an incident analysis program, an incident analysis method, an information processing device, a service identification program, a service identification method, and a service identification device.

### BACKGROUND

A service system is constructed by combining a server (or a physical machine), storage, an operating system (an OS), and an application program. A conventional service system is constructed using in-house hardware resources, and therefore, when an incident occurs in the service system, the cause of the incident is identified by analyzing all messages and error content generated in the service system.

WO 2014/033894 and WO 2014/020908 describe incident detection.

### SUMMARY

One aspect of the present embodiment is a non-transitory computer-readable storage medium that stores therein an incident analysis program for causing a computer to execute a process comprising:

generating a new incident-related request database by extracting,
from a request management database that includes request data in which requests having a plurality of first service systems constructed in a server center of a first cloud service vendor as issuing sources and a plurality of second service systems constructed in a server center of a second cloud service vendor that is different to the first cloud service vendor as issuing destinations, response times to the requests, and timings of the requests are associated with each other,
   new incident-related request data of requests

that are issued at an occurrence time of a new incident occurred in one of the plurality of first service systems and

that are issued from an issuing source first service system to an issuing destination second service system,

the issuing source first service system and the issuing destination second service system being related to a first service system serving as an occurrence source of the new incident;

extracting,
from a plurality of past incident-related request databases generated respectively in relation to a plurality of incidents occurred in the past,
   a past incident-related request database whose transition tendency of the response time has a predetermined correlation with the transition tendency of the response time of the new incident-related request database,

the transition tendency of response times being calculated for the new incident-related request data in the new incident-related request database and for an past incident-related request data in the past incident-related request database, both of which have the same issuing source and issuing destination; and

identifying and outputting information indicating a second service system estimated to be responsible for the past incident in the extracted past incident-related request database, as a second service system estimated to be responsible for the new incident.

According to the first aspect described above, it is possible to estimate a service system that is responsible for an incident occurring in the service systems constructed in a server center of a different cloud vendor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view depicting an example configuration of a service system constructed within a server center of a different cloud service vendor.

FIG. 2 is a view depicting an example configuration of a service system according to a first embodiment.

FIG. 3 is a view depicting an example configuration of the management server 10.

FIG. 4 is a view depicting a relationship between the incident analysis program and the respective databases.

FIG. 5 is a schematic flowchart depicting processing executed by the incident analysis program according to this embodiment.

FIG. 6 is a view illustrating the dummy requests generated by the request issuing program 221.

FIG. 7 is a view illustrating a detailed flowchart of steps S4, S5, and S8 of the incident cause estimation program.

FIG. 8 is a view illustrating a detailed flowchart of step S9.

FIG. 9 is a view illustrating a detailed flowchart of step S10.

FIG. 10 is a view illustrating a detailed flowchart of steps S11 and S12.

FIG. 11 is a view illustrating an example of the request management database 24.

FIG. 12 is a view illustrating an example of the incident database 26.

FIG. 13 is a view illustrating an example of the new incident-related request database.

FIG. 14 is a view illustrating an example of a past incident-related request database 25.

FIG. 15 is a view illustrating a correlation between two response time variation rate waveforms.

FIG. 16 is a flowchart illustrating an incident analysis program according to a second embodiment.

FIG. 17 is a view illustrating an example of the new incident-related request database 25 according to the second embodiment.

### DESCRIPTION OF EMBODIMENTS

As cloud computing services (referred to hereafter as cloud services) become more widespread, service systems are being constructed using hardware, an OS, middleware, and so on provided by a server center of a cloud service vendor (referred to hereafter as a cloud vendor) that provides a cloud service. When a service system is constructed by connecting a plurality of service systems constructed in the server centers of a plurality of cloud vendors to each other by a network, it is particularly difficult to analyze the cause of an incident.

For example, when an incident occurs in a service system in a first server center of a first cloud vendor, an operator of the first cloud vendor can ascertain error content in the first server center, but it is difficult for the operator to ascertain error content in a second server center of a second cloud vendor that is different to the first cloud vendor. As a result, it is impossible to determine which of the service systems in the second server center is responsible for the incident.

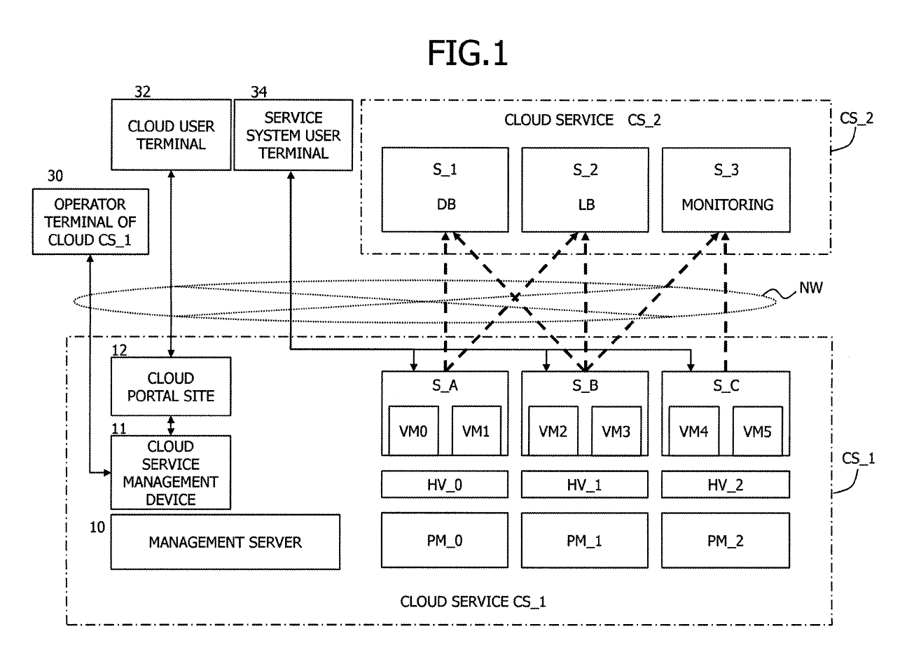

FIG. 1 is a view depicting an example configuration of a service system constructed within server centers of different cloud service vendors. FIG. 1 depicts a center (a server center) of a cloud service CS_1 provided by a first cloud service vendor, and a center (a server center) of a cloud service CS_2 provided by a second cloud service vendor that is different to the first cloud service vendor. Further, in FIG. 1, a cloud user using the cloud service constructs a service system by connecting three first service systems S_A, S_B, S_C, which are constructed using virtual machines VM0 to VM5 generated in physical machines (physical computers) PM_0 to PM_2 provided in the server center of the cloud service CS_1, and three second service systems S_1, S_2, S_3, which are constructed in the server center of the cloud service CS_2, to each other communicably via a network NW. Furthermore, a management server 10 for managing the physical machines and virtual machines is provided in the server center of the cloud service CS_1, and the management server 10 provides a cloud service management device 11, a cloud portal site 12, and so on.

For example, the service system S_A on the side of the server center of the cloud service CS_1 provides a web service of an electronic commerce site, the service system S_B provides a web service of a customer management site of the electronic commerce site, and the service system S_C provides a web service of a busyness management site of the electronic commerce site. Meanwhile, the service system S_1 on the side of the server center of the cloud service CS_2 provides a database service for the electronic commerce site, the service system S_2 provides a load balancer service, and the service system S_3 provides a monitoring service for monitoring the service systems S_B, S_C.

In this service system, a user terminal device 34 of the service system accesses the first service systems S_A, S_B, S_C via the network NW and uses the services provided respectively thereby. In response to access from the user terminal device 34 of the service system, the first service systems S_A, S_B, S_C respectively issue requests as appropriate to the database system S_1, the load balancer S_2, the busyness management service S_3, and so on serving as the second service systems, and execute processing needed by the respective services on the basis of responses to the requests. Therefore, when the responses to the requests issued by the first service systems S_A, S_B, S_C are delayed, the responses by the service system of the first service systems S_A, S_B, S_C to the user terminal device 34 may also be delayed.

Meanwhile, a user terminal 32 of the first cloud service accesses the cloud portal site 12 via the network NW, and initiates construction and activation of the first service systems S_A, S_B, S_C by asking the cloud service management device 11 to generate and activate the virtual machines VM0 to VM5. Further, an operator terminal 30 of the first cloud service CS_1 accesses the cloud service management device 11 via the network NW in order to perform operation management on the first service systems S_A, S_B, S_C. Operation management includes analyzing incidents occurring in the service systems S_A, S_B, S_C and so on.

The centers of two cloud services provided by different vendors typically do not reveal error information generated in the centers of the respective cloud services to each other so that the error information remains confidential. Therefore, when the operator of the first cloud service CS_1 analyzes an incident occurring in the first service systems S_A, S_B, S_C, the operator can ascertain all of the error information generated by the first service systems S_A, S_B, S_C in the server center of the first cloud service CS_1, but is unable to ascertain error information generated by the second service systems S_1, S_2, S_3 in the server center of the second cloud service CS_2. As a result, identification of the service system that is responsible for the incident either involves a large number of steps, or is difficult or impossible.

### First Embodiment

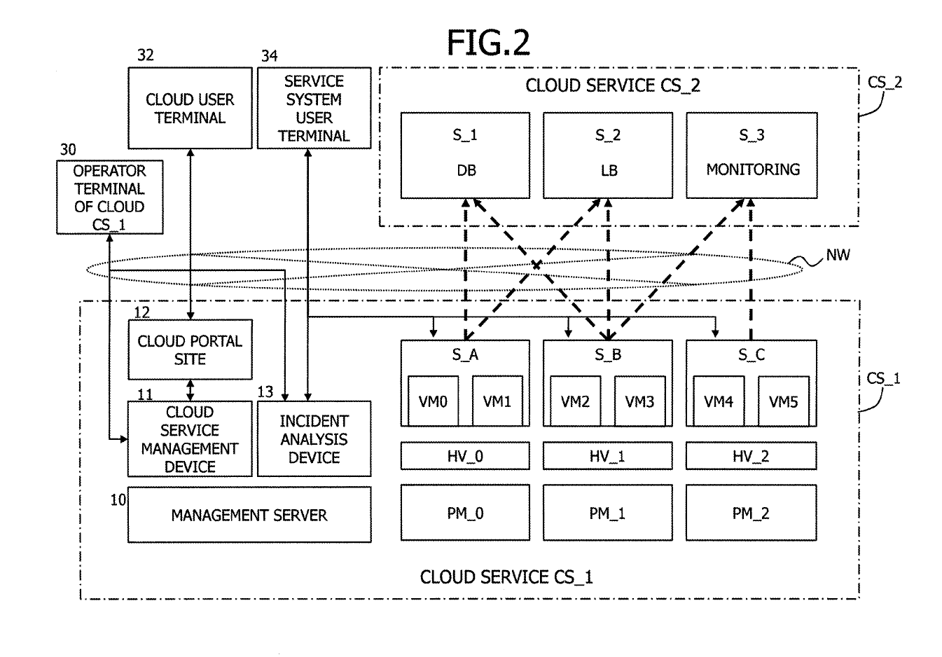

FIG. 2 is a view depicting an example configuration of a service system according to a first embodiment. The example configuration depicted in FIG. 2 differs from the configuration of FIG. 1 in that the management server 10 includes an incident analysis device 13. When the user terminal device 34 of the service system reports an incident occurring in the first service systems S_A, S_B, S_C, the incident analysis device 13 identifies a responsible service system that is estimated to be responsible for the incident. When an incident is reported, the operator terminal device 30 of the first cloud service accesses the incident analysis device 13 and requests analysis of the incident. In response to the analysis request, the incident analysis device 13 identifies the responsible service system estimated to be responsible for the incident, and transmits a response identifying the responsible service system to the operator terminal device 30.

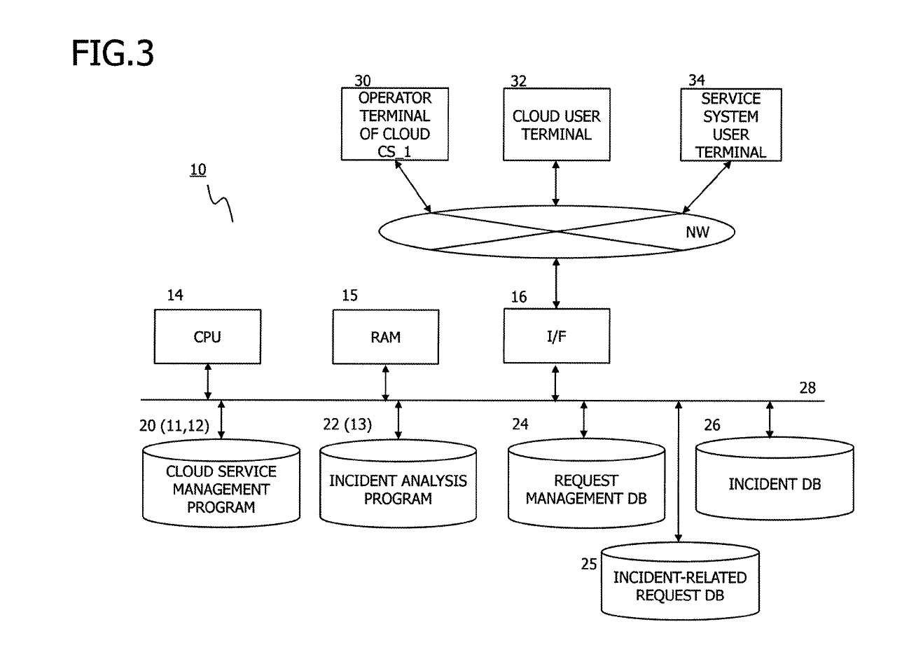

FIG. 3 is a view depicting an example configuration of the management server 10. The management server 10 includes a CPU 14 serving as a processor, a RAM 15 serving as a main memory, an interface device 16 connected to the network NW, and a group of large-capacity auxiliary storage devices 20 to 26, these components being connected to each other via a bus 28.

The auxiliary storage device group stores a cloud service management program 20, an incident analysis program 22, a request management database 24, an incident-related request database 25, and an incident database 26. The cloud service management program 20 and the incident analysis program 22 are expanded in the main memory 15 and executed by the processor 14. The cloud service management device 11 illustrated in FIG. 2 is constructed when the processor 14 executes the cloud service management program 20. Further, the incident analysis device 13 illustrated in FIG. 2 is constructed when the processor executes the incident analysis program 22.

The processor 14 executes the cloud service management program 20 to cause hypervisors HV_1 and HV_2 of the physical machines PM_0 to PM_2 to activate the virtual machines VM_0 to VM_5 constituting the respective service systems in response to a request for activating the first service systems SC_A to SC_C from the user terminal device 32 of the cloud service, for example. Further, the operator terminal device 30 is capable of monitoring error messages from the respective service systems in response to a request for monitoring the first service systems SC_A to SC_C from the operator terminal device 30 of the cloud service.

The processor 14 executes the incident analysis program 22 to add data relating to a newly occurring incident to the incident database 26 in response to an incident report from the user terminal device 34 of the service system, for example. Moreover, the processor 14 issues a plurality of dummy requests, each having a first service system as an issuing source and a second service system as an issuing destination at predetermined time intervals, and adds request data including response times and response messages to the dummy requests and so on to the request management database 24. Furthermore, the processor 14 generates the incident-related request database 25 in response to an incident cause analysis request from the operator terminal device 30 of the cloud service, and identifies the second service system estimated to be responsible for the incident on the basis of the behavior (the response times and messages) of the requests relating to the new incident.

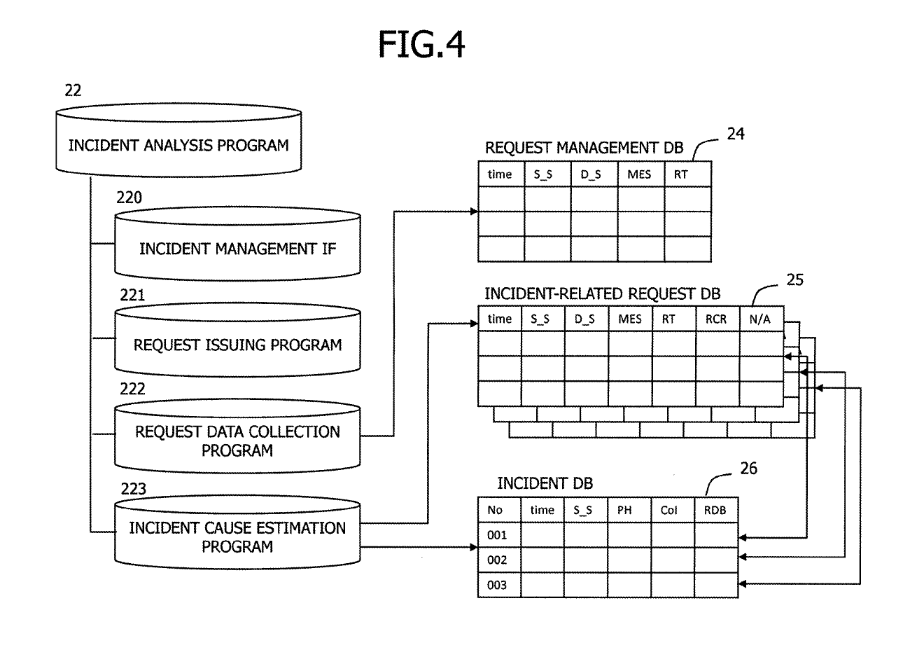

FIG. 4 is a view depicting a relationship between the incident analysis program and the respective databases. The incident analysis program 22 includes an incident management interface 220 that provides the operator terminal device 30 of the cloud service with an interface for an incident management site. The interface 220 provides an incident management screen in response to access to the incident management site from the operator terminal device 30. The operator terminal device 30 displays detailed information relating to the new incident reported by the user terminal device 34 of the service system on the incident management screen. Further, the interface 220 calls up an incident cause estimation program 223 in response to a new incident analysis request from the operator terminal device 30.

The incident analysis program 22 includes a request issuing program 221. The processor executes the request issuing program 221 to issue dummy requests having the first service systems S_A to S_C as issuing sources and the second service systems S_1 to S_3 as issuing destinations successively at predetermined time intervals. The request issuing program 221 measures the response times to the successively issued dummy requests, and obtains corresponding response messages.

The incident analysis program 22 includes a request data collection program 222. The processor executes the request data collection program 222 to collect request data associating each dummy request with the issuing source service system (S_S) and issuing destination service system (D_S) of the request, the request issuing time (time), and the response time (RT), and add the collected request data to the request management database 24. A response message (MES) to the request may be included in the request data.

The processor executes the incident cause estimation program 223 to generate the incident-related request database 25 including the request data at the new incident by extracting the request data generated at the occurrence time of the new incident from the request management database 24. The extracted request data may affect the operation or running of the service system, that is the occurrence source of the new incident. The request data that may affect the operation or running will be described below. Accordingly, the incident-related request database 25 includes a group of incident-related requests generated at the occurrence time of the new incident, and a group of incident-related requests generated at the occurrence times of past incidents.

Further, when the processor executes the incident cause estimation program to, when a new incident occurs, add, to the incident data base 26, incident data in which the occurrence time (time) of the incident, the first service system (S_S) serving as the occurrence source of the incident, and a phenomenon (PH) caused by the incident are associated with each other. The incident-related request database 25 is associated with each of the incidents in the incident database 26. Further, with respect to a past incident, the incident database 26 includes information indicating the responsible service system (CoI) estimated to be responsible for the incident, and with respect to the new incident, information indicating the responsible service system estimated by the incident cause estimation program will be added to the incident database 26.

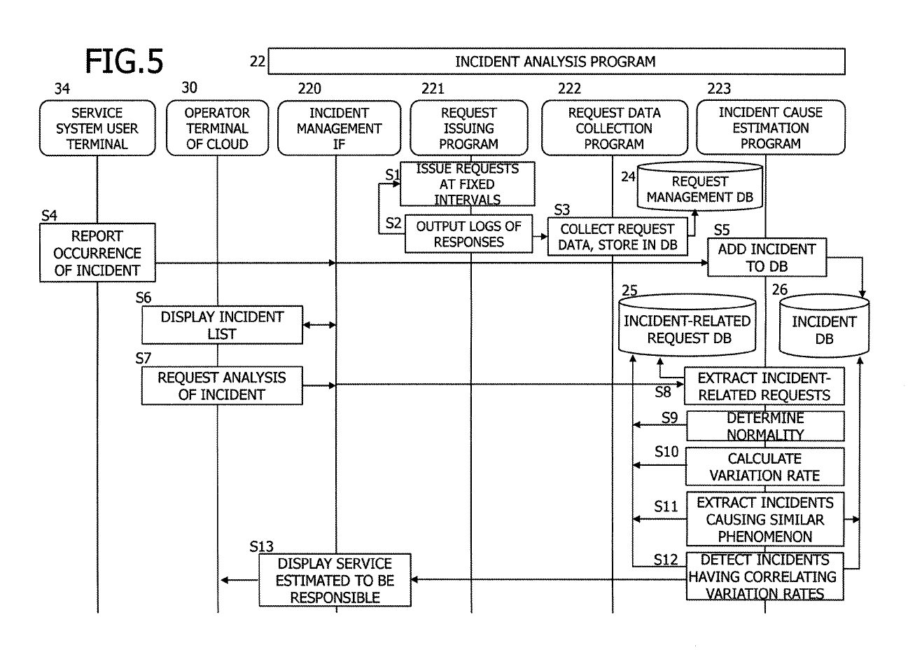

FIG. 5 is a schematic flowchart depicting processing executed by the incident analysis program according to this embodiment. In addition to the incident analysis program 22, FIG. 5 illustrates processing executed by the user terminal device 34 of the service system and the cloud operator terminal device 30.

[Request Data Collection]

First, the processor of the management server 10 executes the request issuing program 221 and the request data collection program 222 at all times to issue the dummy requests at predetermined time intervals (S1) and output logs including the response times and response messages to the dummy requests (S2). Then, the processor collects request data which associates each dummy request, the first service system and second service system serving respectively as the issuing source and issuing destination thereof, the issuing time thereof, the response time and response message and add the request data to the request management database 24 (S3).

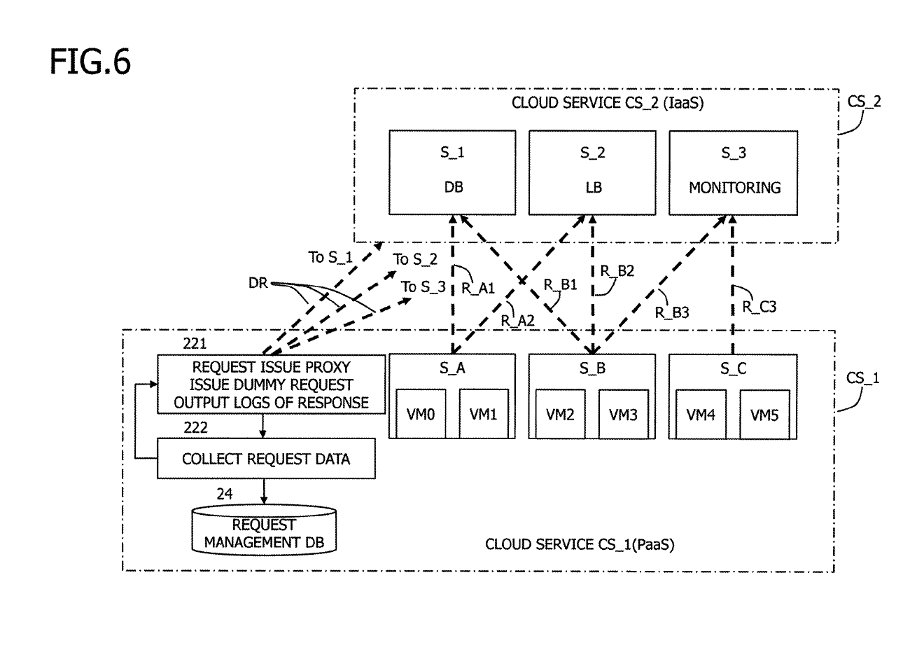

FIG. 6 is a view illustrating the dummy requests generated by the request issuing program 221. In FIG. 6, similarly to FIG. 2, the three first service systems S_A, S_B, S_C are generated in the server center of the first cloud service CS_1, the three second service systems S_1, S_2, S_3 are generated in the server center of the second cloud service CS_2, and the first service systems and second service systems are connected to each other communicably.

Further, in the example illustrated in FIG. 6, the first cloud service CS_1 is a PaaS (Platform as a Service), for example, and the second cloud service CS_2 is an Iaas (Infrastructure as a Service), for example. Note, however, that since the object is for the vendor of the first cloud service to estimate which of the second service systems is responsible for an incident occurring in one of the first service systems in a case where the vendor of the first cloud service and the vendor of the second cloud service are different, the first and second cloud services may be either a Paas or an Iaas, as long as the services are provided by different cloud service vendors.

In the example illustrated in FIG. 6, the first service system S_A constructed within the first cloud service CS_1 issues requests R_A1, R_A2 to the two second service system S_1, S_2 constructed within the second cloud service CS_2. Further, the first service system S_B issues requests R_B1, R_B2, R_B3 to the three second service systems S_1, S_2, S_3 and the first service system S_C issues a request R_C3 to the single second service system S_3. In this case, six requests are issued by the three first service systems to the second service systems.

The incident analysis program 22 of the incident analysis device 13 provided in the first cloud service includes the request issuing program 221 and the request data collection program 222. When the request issuing program 221 is executed, six dummy requests DR as described above are issued to the second service systems at certain time intervals of five minutes or the like, whereupon logs of responses (response messages and response times) to the respective requests are output. Further, when the request data collection program 222 is executed, request data in which the times (issuing times or measurement times), issuing source service systems, issuing destination service systems, response messages, and response times of the six dummy requests are associated with each other are collected and added to the request management database 24.

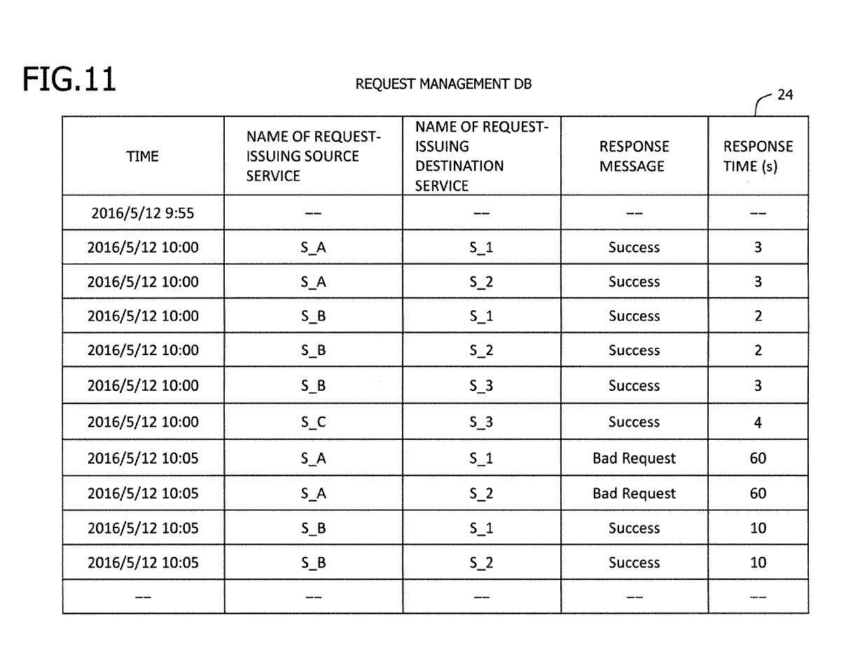

FIG. 11 is a view illustrating an example of the request management database 24. The request management database 24 is a collection of request data in which the times (issuing times or measurement times), issuing source service system names, issuing destination service system names, response messages, and response times of the six dummy requests are associated with each other. In the example illustrated in FIG. 11, the six dummy requests described above are issued at 10:00 on May 12, 2016, and the same six dummy requests (four of which are depicted in FIG. 11) are issued five minutes later at 10:05 on May 12, 2016. The six dummy requests issued at 10:00 all have response messages indicating Success and comparatively short response times of 3 seconds, 3 seconds, 2 seconds, 2 seconds, 3 seconds, and 4 seconds, respectively. Of the six dummy requests issued five minutes later at 10:05, however, the two dummy requests having the service system S_A as the issuing source and the service systems S_1, S_2 as the respective issuing destinations have response messages indicating Bad Request and comparatively long response times of 60 seconds, while the two dummy request having S_B as the issuing source and S_1, S_2 as the respective issuing destinations have response messages indicating Success but comparatively long response times of 10 seconds. Records relating to the remaining two dummy requests have been omitted from FIG. 11.

Hence, the request management database collects the request data relating to the dummy requests in accordance with combinations of the issuing source service system and the issuing destination service system. Further, by issuing the dummy requests are issued periodically by executing the request issuing program 221 and the request data collection program 222, separately to requests normally issued by the user systems of the cloud services, the conditions of the service systems in the server center of the second cloud service can be gathered from the information of the responses to the dummy requests while minimizing the effect on the operation or running of the user system.

[Incident Data Collection]

Returning to FIG. 5, when the occurrence of an incident is reported, the processor 14 executes the incident cause estimation program 223 of the incident analysis program 22. As illustrated in FIG. 5, for example, the user terminal device 34 of the service system issues a notification indicating the occurrence of an incident in one of the first service systems (S4). In response to the notification, the processor executes the incident cause estimation program 223 to add incident data associating the occurred incident with the occurrence time of the incident, the service system serving as the occurrence source of the incident, and the phenomenon caused by the incident to the incident database 26 (S5). The phenomenon caused by the incident may be a delay in the operation of the service system leading to a delay in the response to access, an incorrect response to access, an error generated in response to access, and so on, for example.

[Incident Cause Estimation]

Meanwhile, a list of past incidents and the newly occurring incident is displayed on the operator terminal device 30 of the cloud service (S6). When the operator specifies the newly occurring incident and issues an analysis request in relation thereto on the operator terminal device (S7), the processor executes the incident cause estimation program to implement the following processing. The following processing does not have to be implemented when a new incident occurs, and may be implemented at a predetermined timing following the occurrence of a new incident. Note, however, that when the processing is implemented immediately after the occurrence of a new incident, the result would be useful for estimating the cause of an incident occurring subsequently, and therefore the processing is preferably implemented immediately after occurrence.

[Extraction of Incident-Related Request Data]

First, upon execution of the incident cause estimation program, the processor generates the incident-related request database 25 including the request data generated at the new incident by extracting, from the request management database 24, the request data that is generated at the occurrence time (an occurrence time block) of the new incident and is related to the first service system serving as the occurrence source of the new incident (S8).

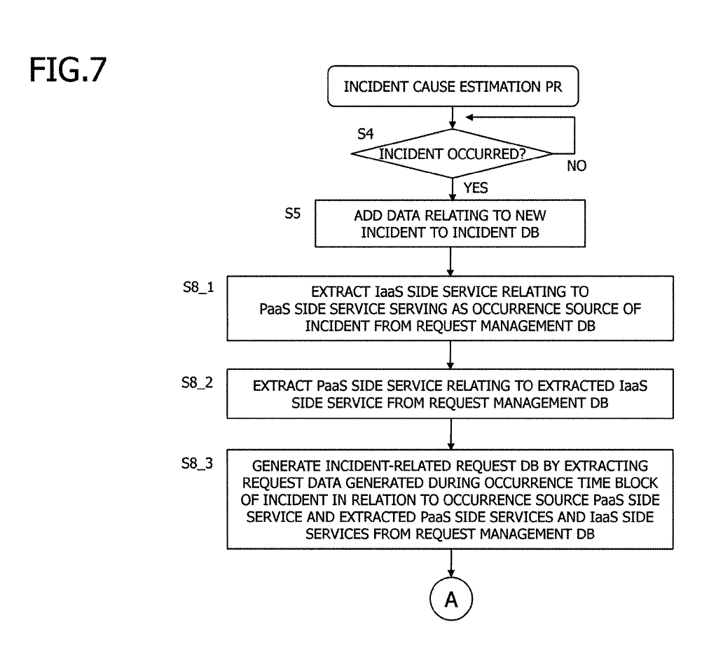

FIG. 7 is a view illustrating a detailed flowchart of steps S4, S5, and S8 of the incident cause estimation program. As described above, when a new incident occurs (S4), the processor executes the incident cause estimation program to add data relating to the new incident to the incident database 26 at a predetermined timing following occurrence (S5).

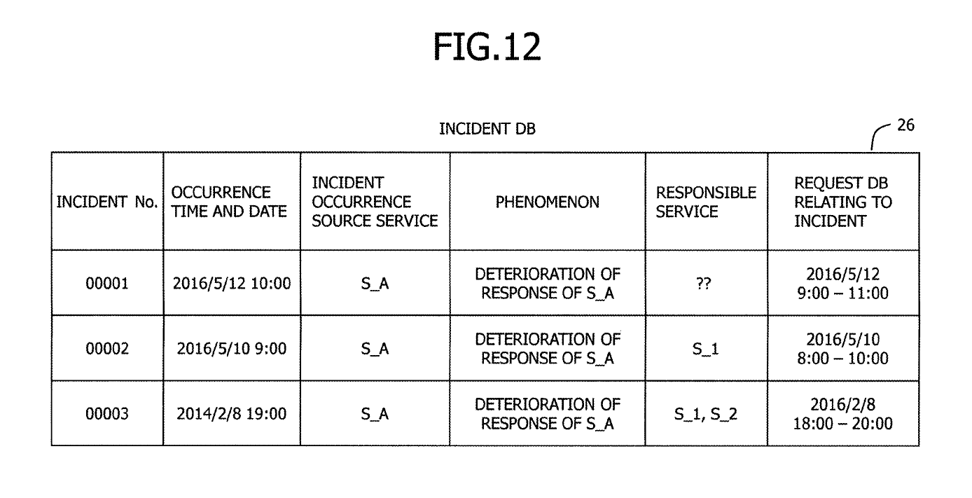

FIG. 12 is a view illustrating an example of the incident database 26. In the example illustrated in FIG. 12, an incident number 00001 indicates the data relating to the new incident, while incident numbers 00002 and 00003 indicate data relating to past incidents. In the data relating to each incident, the date and time at which the incident occurred, the name of the service serving as the occurrence source of the incident, and the phenomenon caused by the incident are associated with each other. The name of the responsible service estimated to be responsible for the incident is recorded in relation to each of the past incidents, but since the new incident (00001) has not yet been analyzed, the responsible service is not recorded in relation thereto. Further, the request database relating to each incident is associated with each incident by information indicating the time block of the request data in the request database.

In the example illustrated in FIG. 12, all of the incident data have S_A as the name of the occurrence source service and “Deterioration of the response of S_A” as the phenomenon. More specifically, in this example, the user of the service system discovered a phenomenon in which the response to access deteriorates while the user of the service system uses the service system S_A, and therefore reported an incident indicating a phenomenon of “Deterioration of the response of S_A”. Further, the service estimated to be responsible for the past incident (00002) was S_1, and the services estimated to be responsible for the past incident (00003) were S_1 and S_2.

Returning to FIG. 7, when the processor executes the incident cause estimation program to extract request data generated during the time block (approximately one hour before and after occurrence) in which the new incident occurred from the request management database and extract the IaaS side service system relating to the PaaS side service system serving as the occurrence source of the new incident based on the extracted request data (S8_1). In other words, information indicating the issuing destination service system of the requests that have the service system serving as the occurrence source of the new incident as the issuing source. In the example illustrated in FIG. 12, the PaaS side service system serving as the occurrence source of the new incident is S_A, and therefore, in the example illustrated in FIG. 11, the issuing destination service systems S_1, S_2 of the requests having the service system S_A as the issuing source are extracted.

Furthermore, the processor extracts the PaaS side service systems relating to the extracted IaaS side service systems (S_1 and S_2) from the request management database (S8_2). More specifically, the issuing source service systems S_A, S_B of the requests having the extracted service systems as issuing destinations are extracted. In the example illustrated in FIG. 11, the issuing source service systems S_A, S_B of the requests having the service systems S_1, S_2 as issuing destinations are extracted.

The processor then generates a new incident-related request database 25 by extracting the request data that relates to the PaaS side service (S_A) serving as the occurrence source of the incident and the extracted PaaS side services (S_A, S_B) and IaaS side services (S_1, S_2) from the request management database 24 (S8_3).

To describe the extracted request data, in the example illustrated in FIG. 6, the two requests R_A1 and R_A2 have the service system S_A in which the new incident occurred as the issuing source. The responses to these two requests may be directly responsible for the new incident. Further, the two requests R_B1 and R_B2 have the issuing destination service systems S_1, S_2 of the aforesaid two requests as issuing destinations. These two requests may affect the respective operations of the service systems S_1, S_2, and are therefore needed to analyze the IaaS side service system that is responsible for the new incident.

When a problem occurs in the responses to the requests R_A1 and R_B1 but no problems occur in the responses to the requests R_A2 and R_B2, the IaaS side service system S_1 may be estimated as the cause. Further, when a problem occurs in the responses to the requests R_A1 and R_A2 but no problems occur in the responses to the requests R_B1 and R_B2, the PaaS side service system S_A may be estimated as the cause. Hence, the processor generates the new incident-related request database 25 by extracting and adding the request data of the dummy requests needed to pinpoint the service system estimated to be responsible for the new incident from the request management database 24 in accordance with the time block of the new incident.

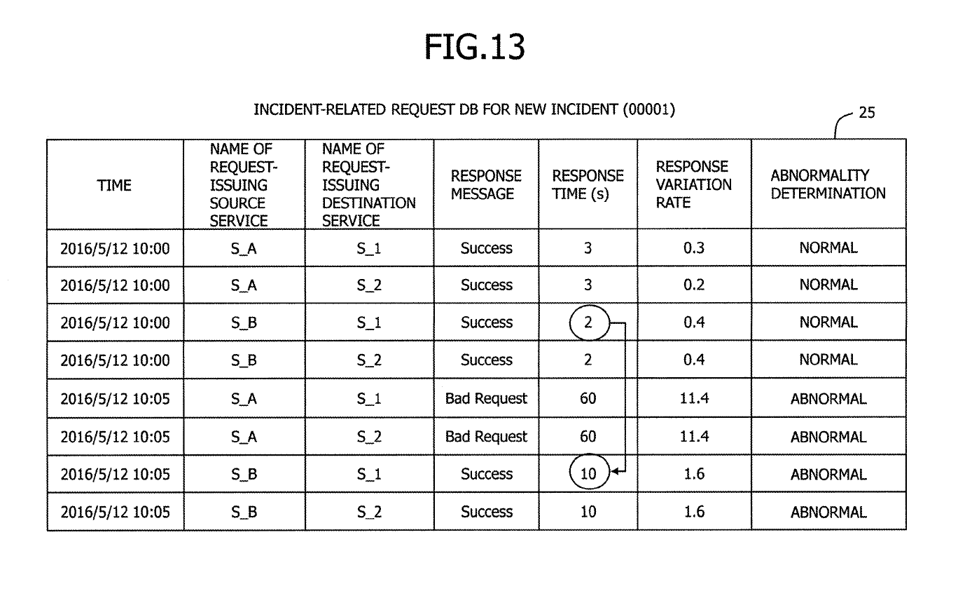

FIG. 13 is a view illustrating an example of the new incident-related request database. As described above, the occurrence source of the new incident is the PaaS side service system S_A, and therefore the new incident-related request database 25 (FIG. 13) is generated by extracting the request data generated in relation to the four requests R_A1, R_A2, R_B1, and R_B2 within approximately one hour before and after the occurrence time of the new incident, namely 10:05 on May 12, 2016, from the request management database 24 (FIG. 11).

The new incident-related request database 25 depicted in FIG. 13 includes response variation rate and irregularity determination columns, but the information in these columns is calculated or determined as appropriate and stored after the new incident-related request database 25 is generated. Therefore, the information in these columns is not yet stored at the time of step S8, when the new incident-related request database is generated.

[Request Data Normality Determination]

Returning to FIG. 5, upon execution of the incident cause estimation program, the processor determines that the respective request data in the new incident-related request database are abnormal when the response time of each request data exceeds a predetermined threshold value from an average value of the response times of requests collected (approximately one hour) before and after the occurrence time of the new incident and having the same issuing source and issuing destination, and determines that the request data are normal when the response time is within the predetermined threshold value from the average value (S9). The average value of the response times is calculated for every group of requests having the same issuing source and issuing destination. Further, the average value of the response times may be an average value of response times collected during an immediately preceding normal period.

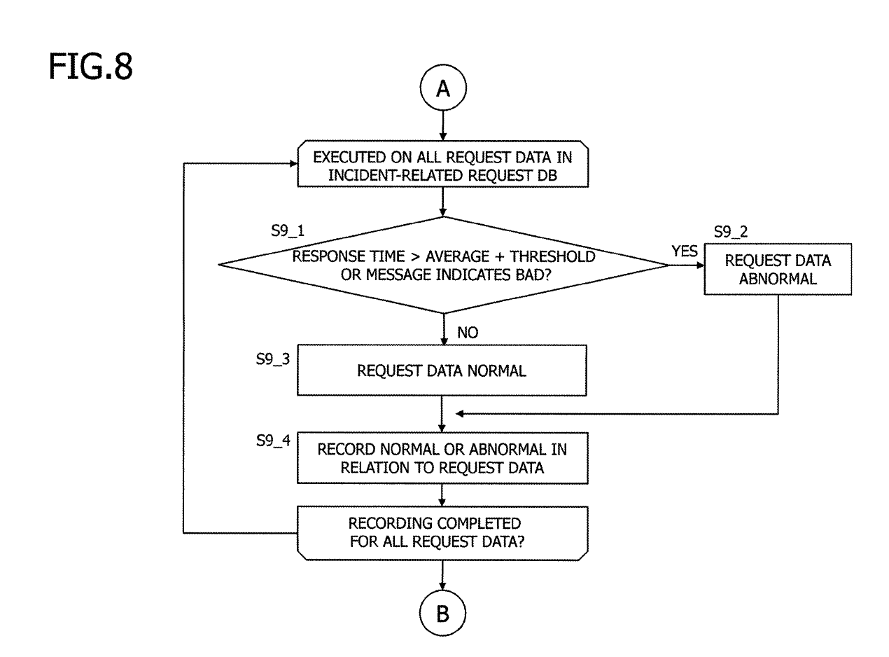

FIG. 8 is a view illustrating a detailed flowchart of step S9. The processor executes the incident cause estimation program to execute the following processing on all of the request data in the new incident-related request database 25 of FIG. 13. The processor determines whether or not each response time exceeds the predetermined threshold value from the average value of the response times of the requests collected at all times and having the same issuing source and issuing destination, or whether or not the response message indicates a bad request (S9_1). When either one of the determinations is affirmative, the request data are determined to be abnormal (S9_2), and when both determinations are negative, the request data are determined to be normal (S9_3). As illustrated in FIG. 13, the normal or abnormal determination is recorded on the abnormality determination column of the request DB 25 (S9_4).

In FIG. 13, “Normal” is recorded to the request data obtained at and before 10:00 on May 12, 2016, while “Abnormal” is recorded to the request data obtained at and after 10:05. From these determinations, it may be estimated that the incident occurred between 10:00 and 10:05. On the basis of the estimated incident occurrence time, a correlation of a transition tendency of the response time, for example the variation rate of the response time, is determined for each request (each request having the same issuing source and issuing destination) in an incident-related response DB for the new incident and past incidents, to be described below.

[Calculation of Response Variation Rate]

Returning to FIG. 5, upon execution of the incident cause estimation program, the processor calculates the variation rate of the response times of requests, a pair of requests, having the same issuing source and issuing destination in the new incident-related request database 25 (S10).

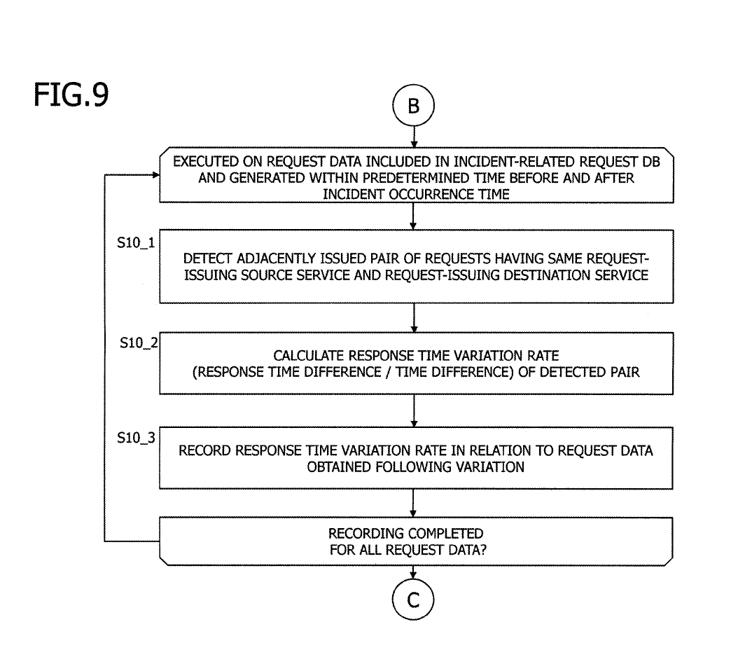

FIG. 9 is a view illustrating a detailed flowchart of step S10. The processor calculates the variation rates of the response times in relation to request data obtained within a predetermined time (approximately 10 minutes, i.e. two sets of request data, for example) before and after the estimated incident occurrence time, among the request data in the new incident-related request database 25 (FIG. 13), by implementing the following processing. First, the processor detects an adjacently issued pair of requests having the same request-issuing source service system and request-issuing destination service system (S10_1). In the example illustrated in FIG. 13, a pair of requests issued at 10:00 and 10:05 and having S_B as the issuing source service system and S_1 as the issuing destination service system, for example, are detected.

The processor then calculates the variation rate of the response times of the detected pair of requests (S10_2). The variation rate of the response times is determined by dividing a difference between the respective response times of the pair of requests by the issued time difference therebetween. In the case of the two response times indicated by circles in FIG. 13, the variation rate of the response times is

Variation rate=(10−2)/(10:05−10:00)=1.6 s/min.

Accordingly, the calculation result 1.6 is recorded in the response variation rate column of the request data obtained after the variation (S10_3). The values in the response variation rate column of FIG. 13 are calculated in a similar manner. For example, the response variation rates of the four sets of request data obtained at 10:00 are variation rates relative to the response times of four sets of request data obtained at 9:55, not depicted in the figure, while the values of the response variation rates of the four sets of request data obtained at 10:05 are variation rates relative to the response times of the four sets of request data obtained at 10:00.

[Detection of Similar Past Incidents]

Returning to FIG. 5, upon execution of the incident cause estimation program, the processor extracts past incidents having the same incident occurrence source service system and phenomenon as the new incident from the incident database 26 (S11). Further, among the extracted past incidents, the processor detects a past incident that has a request having a correlation with (a similarity to, for example) the response time variation rate of the request of the new incident (S12). The correlation is a correlation between the response time variation rates of the requests having the same issuing source and issuing destination, and is calculated by making associations between the requests relating to the new incident and the past incident using the incident occurrence times as a reference.

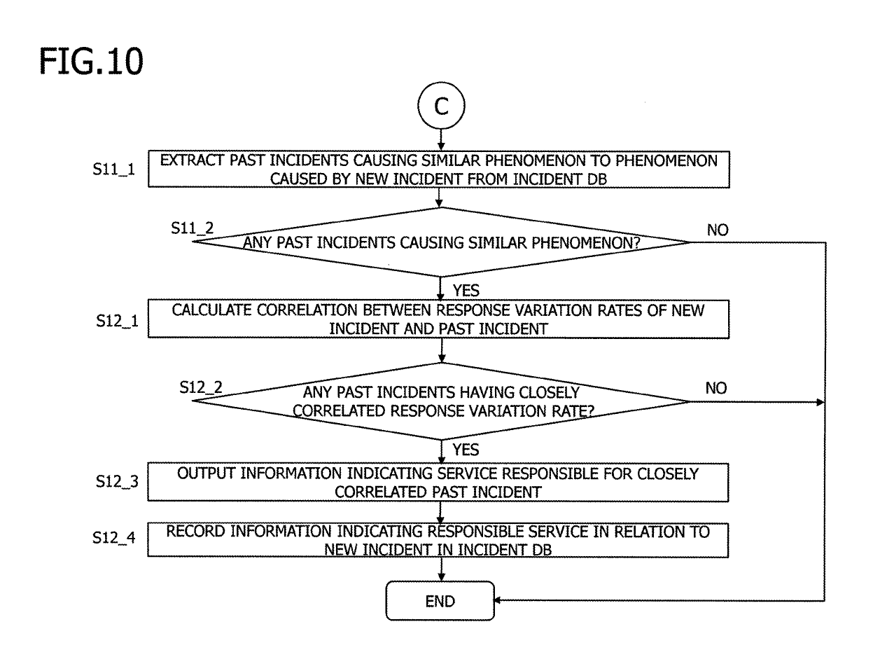

FIG. 10 is a view illustrating a detailed flowchart of steps S11 and S12. Upon execution of the incident cause estimation program, the processor extracts past incidents having an identical incident occurrence source service system and an identical or similar phenomenon to the new incident from the incident database 26 (S11_1). When, at this time, a past incident having a similar phenomenon exists (YES in S11_2), the processor calculates the correlation between the respective response variation rates (response time variation rates) of the pair of requests at the new incident and the past incident (S12_1).

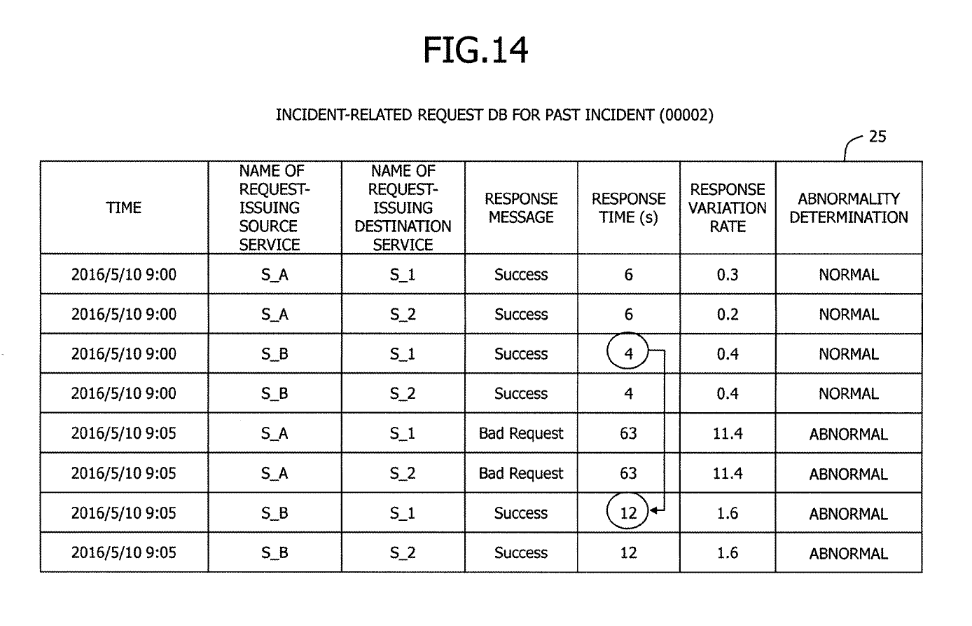

FIG. 14 is a view illustrating an example of a past incident-related request database 25. This example depicts a database of requests issued within a time block of 9:00 to 9:05 on May 10, 2016. As described above, past incidents having the same incident occurrence source service system are extracted from the incident database, and therefore data relating to the same four requests as those in the new incident-related request database (FIG. 13) are stored in the incident-related request database associated with the past incidents.

Next, correlations between the response variation rates (response time variation rates) of the pair of request at the new incident and the past incidents are calculated using a correlation coefficient such as that illustrated below, for example.

Correlation coefficient=[{Σ(F(k)−F′)(G(k)−G′)}/n]÷[√{Σ(F(k)−F′)²/n}√{Σ(G(k)−G′)²/n}]

Here, the two roots (√) of the divisors are respectively square roots of {Σ(F(k)−F′)²/n} and {Σ(G(k)−G′)²/n}. Further, n denotes a number of samples, Σ denotes an accumulation of the n samples, F(k) is the response variation rate waveform of the new incident, G(k) is the response variation rate waveform of the past incident, and F′ and G′ denote average values.

More specifically, the response variation rates of the adjacently issued pair of requests having the issuing source S_B and the issuing destination S_1 in the new incident-related request database depicted in FIG. 13 are “0.4” and “1.6”, and the response variation rates of the adjacently issued pair of requests having the issuing source S_B and the issuing destination S_1 in the past incident-related request database depicted in FIG. 14 are also “0.4” and “1.6”. In this case, the correlation coefficient calculated using the above correlation coefficient formula is “1.0”, and therefore the correlation coefficient is very high.

The above correlation coefficient is calculated in relation to values at respective sample points on two waveforms in order to determine a correlation between the two waveforms. Typically, a correlation coefficient between 0.4 and 0.7 is considered to indicate a close correlation, and a correlation coefficient between 0.7 and 1.0 is considered to indicate a very close correlation.

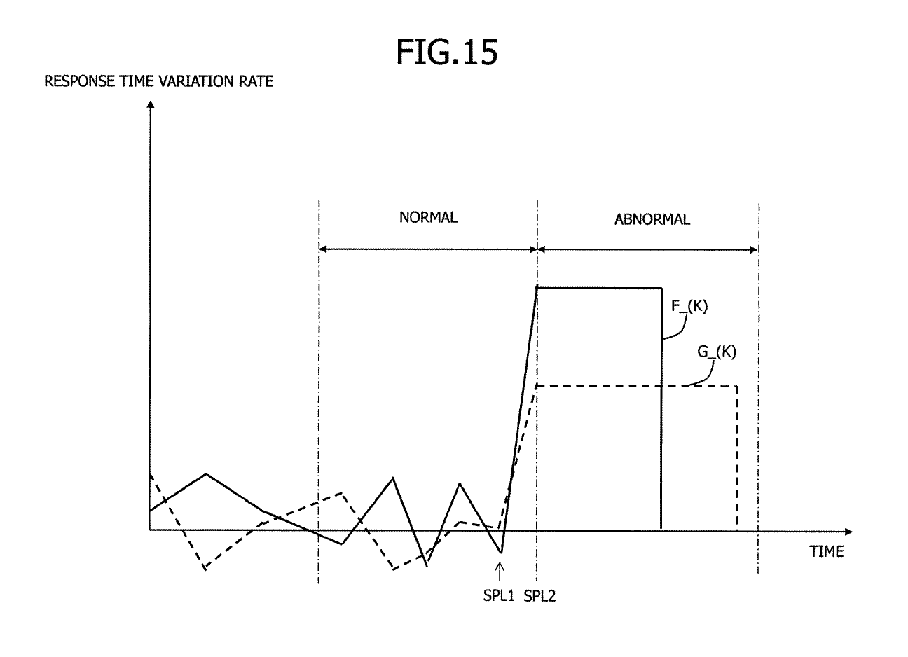

FIG. 15 is a view illustrating a correlation between two response time variation rate waveforms. For example, a solid line denotes a response time variation rate waveform F(k) of a request having a certain issuing source and a certain issuing destination and relating to the new incident, while a dotted line denotes a response time variation rate waveform G(k) of a request having the same issuing source and issuing destination and relating to a past incident. The variation rate varies at each sample point.

Taking an interval between a final sample point SPL1 at which a normal determination is made and a first sample point SPL2 at which an abnormal determination is made in determination step S9, described above, as the estimated occurrence time of the incident, the correlation between the two waveforms is determined from the above correlation coefficient formula in relation to variation rates at a plurality of sample points before and after the estimated occurrence time, which are associated with each other using the estimated occurrence time as a reference.

For example, when the response time variation rates at the sample points SPL1 and SPL2, which are considered to have the greatest effect on the similarity between the incidents, are identical or similar, the waveforms of the two incidents are determined to be closely correlated. By determining whether or not the response time variation rate waveforms during the normal period at or before the sample point SPL1 and the response time variation rate waveforms during the abnormal period at or after the sample point SPL2 are identical or similar, the precision with which a similar past incident is extracted can be improved.

By determining whether or not the correlation value is high in this manner, a determination can be made as to whether or not the temporal waveforms (patterns) of the response time variation rates of the corresponding requests of two incidents are similar using the incident occurrence time as a reference.

The response times and response time variation rates in the new incident-related request DB depicted in FIG. 13 and the past incident-related request DB depicted in FIG. 14 will now be described.

In the new incident-related request DB depicted in FIG. 13, the respective response times of the request data are “3, 3, 2, 2, 60, 60, 10, 10”. In the past incident-related request DB depicted in FIG. 14, meanwhile, the respective response times of the request data are “6, 6, 4, 4, 63, 63, 12, 12”. In this example, the response times to the requests issued in the time block 9:00 to 9:05 on May 10, 2016, during which the past incident occurred, were long, but by having the load balancer scale out the IaaS side service systems S_1, S_2 so as to increase the numbers of virtual machines of the respective service systems, the response times in the time block 10:00 to 10:05 on May 12, 2016, during which the new incident occurred, are shortened.

However, the two incidents have identical occurrence source service systems and phenomena but different response times, while the waveforms of the response time variation rates are similar. In this case, therefore, according to this embodiment, the two incidents are determined to be similar incidents caused by the same responsible service system. As a feature of the service systems constructed in the cloud services is that the load balancer shortens the response times by implementing scale-out processing and lengthens the response times by implementing scale-in processing (i.e. reducing the number of virtual machines) as appropriate. Therefore, when the correlation between the two incidents is checked, the correlation between the response time variation rates rather than the correlation between the response times themselves is preferably checked in order to reduce the effect of the control executed by the load balancer.

Further, when calculating the correlation, a similar past incident may be detected by calculating four correlations between the response time variation rates of the four dummy requests relating to the new incident and the past incident.

Returning to FIG. 5, when the processor, upon execution of the incident cause estimation program, detects a past incident that correlates with the response time variation rate of the new incident (S12), the processor extracts the information indicating the service system identified as the cause of the detected past incident from the incident DB, whereupon the incident management interface displays the responsible service system as the service system estimated to be responsible for the new incident. A response to the analysis request is then transmitted to the operator (S13).

According to the examples illustrated in FIGS. 12, 13, and 14, the incident number 00002 in the incident database depicted in FIG. 12 is determined to have a correlation with the new incident 00001 in terms of the response time variation rate, and the service system S_1 that is responsible for the past incident having the incident number 00002 is estimated to be responsible for the new incident. Information indicating the estimated responsible service system is then stored in the incident database 26 in relation to the new incident 00001.

According to the first embodiment, as described above, the incident analysis device of the management server issues dummy requests addressed to the second service systems of the second cloud service from the first service systems of the first cloud service at predetermined time intervals, and adds request data associating the dummy requests with information indicating the issuing sources and issuing destinations thereof, the response messages and response times thereto, and the issuing times thereof to the request management DB. Then, when an incident occurs, a new incident-related request DB is generated by extracting from the request management DB the request data generated during the incident occurrence time block in relation to the service system serving as the occurrence source of the incident. A past incident having a correlation with the new incident in terms of the respective response time variation rates of the dummy requests thereof is then detected from among past incidents, whereupon the service system that was responsible for the past incident is estimated to be responsible for the new incident.

A feature of the cloud service is that the configurations of the respective service systems vary over time. In this embodiment, variation in the response times due to these changes in the configurations of the service systems is taken into account such that the correlation between the incidents is checked using the correlation between the response time variation rates.

### Modified Example of First Embodiment

In a modified example of the first embodiment, during the processing for identifying a similar past incident to the new incident, as well as determining the correlation between the response time variation rates of requests having the same issuing source and issuing destination among the incident-related request data, whether or not the incidents have identical response messages and identical normal/abnormal determination results may also be used as determination references. Furthermore, the presence of a correlation may be determined using these determination references in relation to each of a plurality of requests having a plurality of combinations of issuing sources and issuing destinations.

### Second Embodiment

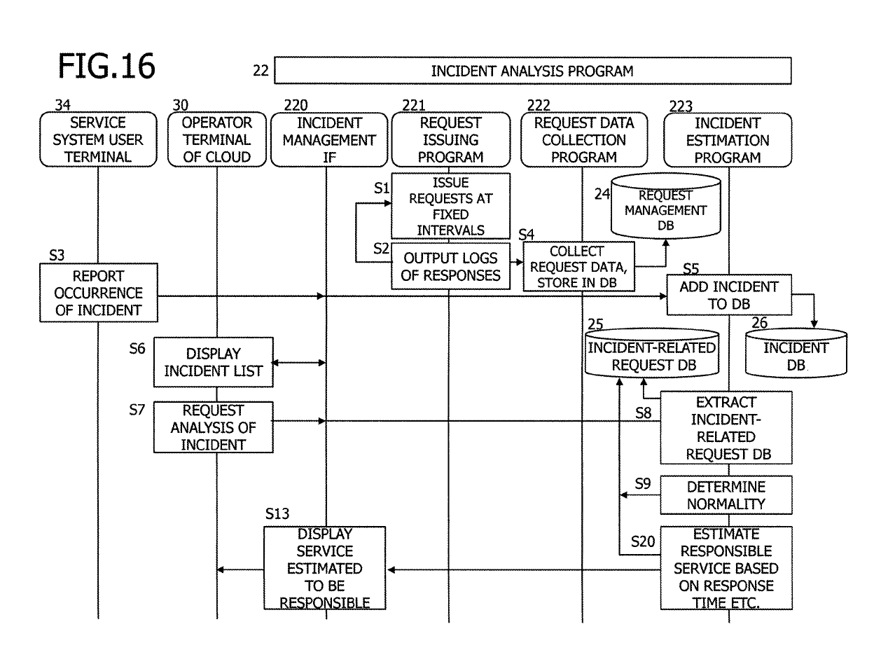

FIG. 16 is a flowchart illustrating an incident analysis program according to a second embodiment. In the second embodiment, the processor executes the incident analysis program, whereupon dummy requests addressed to the second service systems S_1, S_2, S_3 of the second cloud service CS_2 are issued from the first service systems S_A, S_B, S_C of the first cloud service CS_1 at predetermined time intervals (S1) and request data associating the dummy requests with information indicating the issuing sources and issuing destinations thereof, the response messages and response times thereto, and the issuing times thereof are added to the request management DB (S3). These points are similar to the first embodiment.

When the occurrence of a new incident is reported (S4), the processor adds data relating to the new incident to the incident database 26 (S5). Further, when the operator terminal device 30 of the cloud service specifies the new incident from the incident list display screen (S6) such that an analysis request is received in relation to the incident (S7), the processor executes the incident cause estimation program in order to generate the incident-related request database 25 in relation to the new incident (S8). The new incident-related request database is generated in an identical manner to the first embodiment.

Further, the processor determines that the respective requests in the new incident-related request database are abnormal when the response times thereof exceed the threshold set in relation to the average value, determines that the requests are normal when the response times thereof are within the threshold, and then adds the determination results to the database (S9). This processing is also identical to the processing of the first embodiment.

Finally, the processor estimates the second service system that is responsible for the incident on the basis of the response times, response messages, and normal/abnormal determination results of the requests in the new incident-related request database (S20). The service estimated to be responsible is then displayed by the incident management interface (S13).

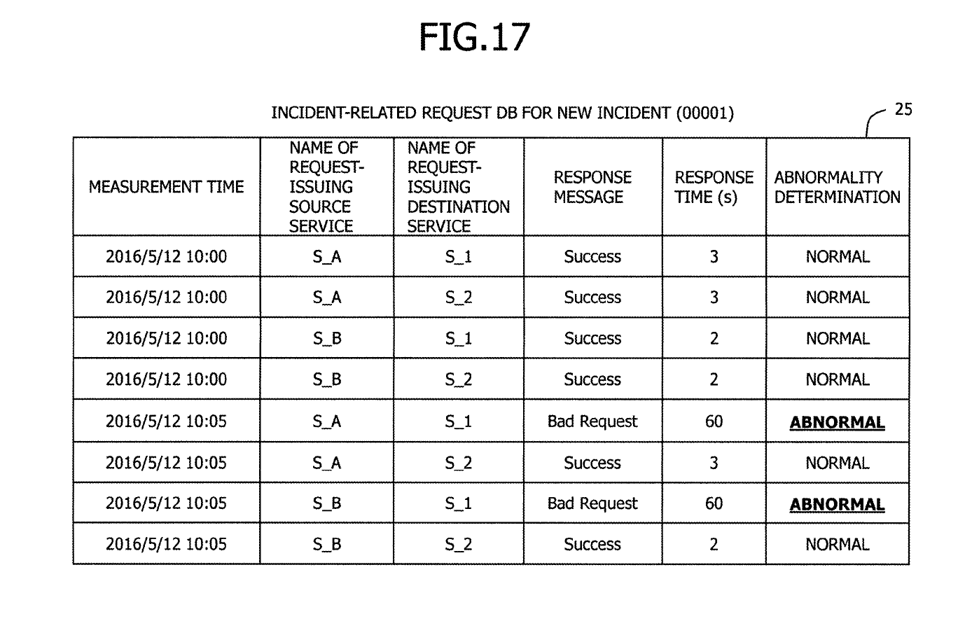

FIG. 17 is a view illustrating an example of the new incident-related request database 25 according to the second embodiment. According to this example, requests issued from 10:05 onward include requests in which the response message indicates Bad Request and requests in which the response time differs from the average value by more than the threshold such that the requests are determined to be abnormal. More specifically, the combinations of request-issuing source and request-issuing destination service systems that are determined to be abnormal are S_A and S_1, and S_B and S_1, while the request-issuing source and request-issuing destination combinations that are determined to be normal are S_A and S_2, and S_B and S_2.

In this case, the processor, upon execution of the incident cause estimation program, estimates that a problem has occurred in the service system S_1, and that the service system S_1 is responsible for a new incident.

The service system that is responsible for the new incident may be estimated by performing a similar analysis to that described above on the basis of the issuing sources and issuing destinations of the requests having “Bad Request” as the response message thereto.

According to the second embodiment, as described above, even though it is not possible to obtain error information and operation information relating to the second service systems constructed in the second cloud service operated by someone else, the incident analysis device of the first cloud service operated by oneself issues dummy requests having the first service systems as issuing sources and the second service systems as issuing destinations at predetermined time intervals, and accumulates request data including response information relating thereto in the request management database. Then, when an incident occurs, the request data that affect the service system serving as the occurrence source of the incident are extracted and analyzed, and as a result, the second service system estimated to be responsible for the incident is identified.

The incident analysis program, incident analysis method, and incident analysis device described above respectively correspond to a program, a method, and a device for identifying a responsible incident.

The “service” in claims 13, 14, and 15 corresponds to a service system, and the “request” corresponds to a request. Further, the “incident relating to a response time to a request issued by the service” corresponds to an incident in which the response time to the request issued by the service system is long. Furthermore, the “service identification information” and the “output service identification information” correspond to information identifying the service system that issued the request and output information identifying the service system that issued the request.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium that stores therein an incident analysis program for causing a computer to execute a process comprising:
generating a new incident-related request database by extracting,
from a request management database that includes request data in which requests having a plurality of first service systems constructed in a server center of a first cloud service vendor as issuing sources and a plurality of second service systems constructed in a server center of a second cloud service vendor that is different to the first cloud service vendor as issuing destinations, response times to the requests, and timings of the requests are associated with each other,
new incident-related request data of requests
that are issued at an occurrence time of a new incident occurred in one of the plurality of first service systems and
that are issued from an issuing source first service system to an issuing destination second service system,
the issuing source first service system and the issuing destination second service system being related to a first service system serving as an occurrence source of the new incident;
extracting,
from a plurality of past incident-related request databases generated respectively in relation to a plurality of incidents occurred in the past,
a past incident-related request database whose transition tendency of the response time has a predetermined correlation with the transition tendency of the response time of the new incident-related request database,
the transition tendency of response times being calculated for the new incident-related request data in the new incident-related request database and for an past incident-related request data in the past incident-related request database, both of which have the same issuing source and issuing destination; and
identifying and outputting information indicating a second service system estimated to be responsible for the past incident in the extracted past incident-related request database, as a second service system estimated to be responsible for the new incident.

2. The non-transitory computer-readable storage medium according to claim 1, the process further comprising:
issuing a plurality of requests having the plurality of first service systems as issuing sources and the plurality of second service systems as issuing destinations at a predetermined timing, and adding the request data for the issued requests to the request management database.

3. The non-transitory computer-readable storage medium according to claim 1, wherein
the extracting the past incident-related request database includes:
extracting, from an incident database in which past incidents are each associated with incident occurrence source identification information, information indicating a phenomenon caused by the incident, and a responsible second service system estimated to be responsible for the incident, past incidents having an identical issuing source first service system to the new incident and a similar phenomenon to the new incident; and
extracting, from the plurality of past incident-related request databases corresponding to the extracted past incidents, the past incident-related request database having the correlation.

4. The non-transitory computer-readable storage medium according to claim 1, wherein the generating the new incident-related request database includes:
extracting, from the request management database, request data, which is generated at the occurrence time of the new incident, in relation to a first request having the first service system serving as the occurrence source of the new incident as an issuing source and a second request which has an issuing destination second service system of the first request as an issuing destination and from which the first request is excluded.

5. The non-transitory computer-readable storage medium according to claim 1, wherein the transition tendencies of the response times are response time variation rates indicating amounts of variation per a unit of time between the response times of a pair of requests having the same issuing source and issuing destination.

6. The non-transitory computer-readable storage medium according to claim 5, wherein the correlation is a correlation between the response time variation rates of the pair of requests issued before and after an incident occurs.

7. The non-transitory computer-readable storage medium according to claim 6, the process further comprising, before the extracting the past incident-related request database,
determining the request data in the new incident-related request database to be normal when the respective response times thereof are within a threshold value from an average value of the response times, and to be abnormal when the respective response times thereof exceed the threshold from the average value, and
calculating the response time variation rates for request data generated within a predetermined time before and after a boundary timing between the normal request data and the abnormal request data.

8. The non-transitory computer-readable storage medium according to claim 7, wherein the extracting the past incident-related request database includes:
determining that the predetermined correlation exists when the response variation rates of a plurality of request data generated within the predetermined time before and after the boundary timing exhibit similar patterns over time.

9. A method of analyzing an incident, comprising:
generating a new incident-related request database by extracting,
from a request management database that includes request data in which requests having a plurality of first service systems constructed in a server center of a first cloud service vendor as issuing sources and a plurality of second service systems constructed in a server center of a second cloud service vendor that is different to the first cloud service vendor as issuing destinations, response times to the requests, and timings of the requests are associated with each other,
new incident-related request data of requests
that are issued at an occurrence time of a new incident occurred in one of the plurality of first service systems and
that are issued from an issuing source first service system to an issuing destination second service system,
the issuing source first service system and the issuing destination second service system being related to a first service system serving as an occurrence source of the new incident;
extracting,
from a plurality of past incident-related request databases generated respectively in relation to a plurality of incidents occurred in the past,
a past incident-related request database whose transition tendency of the response time has a predetermined correlation with the transition tendency of the response time of the new incident-related request database,
the transition tendency of response times being calculated for the new incident-related request data in the new incident-related request database and for an past incident-related request data in the past incident-related request database, both of which have the same issuing source and issuing destination; and
identifying and outputting information indicating a second service system estimated to be responsible for the past incident in the extracted past incident-related request database, as a second service system estimated to be responsible for the new incident.

10. An information processing device comprising:
a memory; and
a processor that accesses the memory, wherein
the processor executes a process including
generating a new incident-related request database by extracting,
from a request management database that includes request data in which requests having a plurality of first service systems constructed in a server center of a first cloud service vendor as issuing sources and a plurality of second service systems constructed in a server center of a second cloud service vendor that is different to the first cloud service vendor as issuing destinations, response times to the requests, and timings of the requests are associated with each other,
new incident-related request data of requests
that are issued at an occurrence time of a new incident occurred in one of the plurality of first service systems and
that are issued from an issuing source first service system to an issuing destination second service system,
the issuing source first service system and the issuing destination second service system being related to a first service system serving as an occurrence source of the new incident;
extracting,
from a plurality of past incident-related request databases generated respectively in relation to a plurality of incidents occurred in the past,
a past incident-related request database whose transition tendency of the response time has a predetermined correlation with the transition tendency of the response time of the new incident-related request database,
the transition tendency of response times being calculated for the new incident-related request data in the new incident-related request database and for an past incident-related request data in the past incident-related request database, both of which have the same issuing source and issuing destination; and
identifying and outputting information indicating a second service system estimated to be responsible for the past incident in the extracted past incident-related request database, as a second service system estimated to be responsible for the new incident.

11. A non-transitory computer-readable storage medium that stores therein an incident analysis program for causing a computer to execute a process comprising:
issuing, at a predetermined timing, a plurality of requests having a plurality of first service systems constructed in a server center of a first cloud service vendor as issuing sources and a plurality of second service systems constructed in a server center of a second cloud service vendor that is different to the first cloud service vendor as issuing destinations, and adding to a request management database request data associating the issued requests with response times to the requests and issued timings of the requests;
generating a new incident-related request database by extracting, from the request management database,
new incident-related request data of requests
that are issued at an occurrence time of a new incident occurred in one of the plurality of first service systems and
that are issued from an issuing source first service system to an issuing destination second service system,
the issuing source first service system and the issuing destination second service system being related to a first service system serving as an occurrence source of the new incident; and
estimating a second service system that is responsible for the new incident on the basis of the response times of the request data included in the new incident-related request database.

12. The non-transitory computer-readable storage medium according to claim 11, wherein the generating the new incident-related request database includes:
extracting, from the request management database, request data, which is generated at the occurrence time of the new incident, in relation to a first request having the first service system serving as the occurrence source of the new incident as an issuing source and a second request which has an issuing destination second service system of the first request as an issuing destination and from which the first request is excluded.

13. A non-transitory computer-readable storage medium that stores therein a service identification program for causing a computer to execute a process comprising:
obtaining service system identification information output in response to occurrence of an incident in which a response time to a request issued by the service system is longer;
by referring to a storage device that stores the service system identification information, identification information indicating an issuing destination service system serving as an issuing destination of the request issued by the service system, and the response time to the request in association with each other, obtaining identification information of the issuing destination service system associated with the obtained service identification information and a response time;
by referring to a storage device that stores the service system identification information, identification information indicating a responsible service system that is responsible for the incident relating to the response time to the request issued by the service system, and information indicating transition tendencies of response times to requests issued prior to the occurrence of the incident in association with each other, identifying, among responsible services associated with the obtained service system identification information, a responsible service system in which the information indicating the transition tendency of the response time has a predetermined correlation with the transition tendency of the obtained response time; and
outputting the identification information of the identified responsible service system.

14. A method of identifying a service, comprising:
obtaining service system identification information output in response to occurrence of an incident in which a response time to a request issued by the service system is longer;
by referring to a storage device that stores the service system identification information, identification information indicating an issuing destination service system serving as an issuing destination of the request issued by the service system, and the response time to the request in association with each other, obtaining identification information of the issuing destination service system associated with the obtained service identification information and a response time;
by referring to a storage device that stores the service system identification information, identification information indicating a responsible service system that is responsible for the incident relating to the response time to the request issued by the service system, and information indicating transition tendencies of response times to requests issued prior to the occurrence of the incident in association with each other, identifying, among responsible services associated with the obtained service system identification information, a responsible service system in which the information indicating the transition tendency of the response time has a predetermined correlation with the transition tendency of the obtained response time; and
outputting the identification information of the identified responsible service system.

15. A service identification device comprising:
a memory; and
a processor that accesses the memory, wherein
the processor executes a process including
obtaining service system identification information output in response to occurrence of an incident in which a response time to a request issued by the service system is longer;
by referring to a storage device that stores the service system identification information, identification information indicating an issuing destination service system serving as an issuing destination of the request issued by the service system, and the response time to the request in association with each other, obtaining identification information of the issuing destination service system associated with the obtained service identification information and a response time;
by referring to a storage device that stores the service system identification information, identification information indicating a responsible service system that is responsible for the incident relating to the response time to the request issued by the service system, and information indicating transition tendencies of response times to requests issued prior to the occurrence of the incident in association with each other, identifying, among responsible services associated with the obtained service system identification information, a responsible service system in which the information indicating the transition tendency of the response time has a predetermined correlation with the transition tendency of the obtained response time; and
outputting the identification information of the identified responsible service system.
